(19) United States
(12) Patent Application Publication
(10) Pub. No.: US 2013/0100665 A1
(43) Pub. Date: Apr. 25, 2013

(54) LIGHTING DEVICE

(71) Applicants: Adrianus Wihelmus Dionisius Maria Van Den Bijgaart, Helvoirt (NL); Genevieve Martin, Berkel-Enschot (NL); Jorrit Ernst De Vries, Culemborg (NL)

(72) Inventors: Adrianus Wihelmus Dionisius Maria Van Den Bijgaart, Helvoirt (NL); Genevieve Martin, Berkel-Enschot (NL); Jorrit Ernst De Vries, Culemborg (NL)

(73) Assignee: KONINKLIJKE PHILIPS ELECTRONICS N.V., Eindhoven (NL)

(21) Appl. No.: 13/805,692

(22) PCT Filed: Jun. 21, 2011
(86) PCT No.: PCT/IB2011/052710

§ 371 Date: Dec. 20, 2012

(30) Foreign Application Priority Data
Jun. 25, 2010 (EP) 10167353.1

(51) Int. Cl. F21V 7/10

(52) U.S. Cl. CPC F21V 7/10
USPC 362/235

(57) ABSTRACT

A lighting device (1) comprising a housing (5) with holding means (7) for fixation of an adjustable reflector (3) inside the housing and comprising a light emission window (9) opposite the reflector. The reflector is provided with fixation means (19) having a fitting structure (21) with respect to the holding means and enabling adjustment of the reflector within the housing. The adjustment comprises a change in shape of the reflector and/or a change in the mutual position of the reflector and a contacting element (15).

### FIELD OF THE INVENTION

The invention relates to a lighting device comprising a housing with holding means for fixation of an adjustable reflector inside the housing, a rim of the housing bordering a light emission window opposite the reflector, and at least one electric contacting element for accommodating at least one light source inside the housing.

### BACKGROUND OF THE INVENTION

Such a lighting device is known from WO2006013495 and is used for projection purposes. In the known lighting device, the light source is a unit of lamp and reflector, which unit is mounted inside a housing. The lamp is immovably fixed and positioned in the reflector. To prevent rotation of the unit inside the housing, the lamp/reflector unit is firmly held in the housing, yet in a manner that still enables (re)positioning of said unit. For this purpose, the reflector is provided on its outer side with projections that come into engagement with saw teeth provided in the inner wall of the housing. The housing has resilient walls to enable insertion of the unit inside the housing and to enable the projections to engage with the saw teeth. The repositioning of the unit inside the housing is desired for improvement of cooling and for aligning the unit in order to improve the projection efficacy. It is a disadvantage of the known lighting device that it is of a relatively complex construction, due to the fact that the lighting device is designed for a permanent position of the reflector inside the housing, as a result of which a relatively firm positioning of the unit inside the housing is desired, for example, to counteract rotation, yet a one-time (re)positioning of the unit should still be possible if it appears that the assumed position does not fulfill the minimum efficacy requirements. However, (re)positioning of the reflector is relatively cumbersome. It is another disadvantage of the known lighting device that for certain applications modification of the shape of the light beam as issued by the unit during its operation is not enabled. It is yet another disadvantage of the known lighting device that its manufacture is relatively complex, as providing the protrusions on the reflector without distortion of the reflective portion is relatively cumbersome since the projections are located on the side of the wall other than that on which the reflective layer of the reflective portion of the reflector is provided.

### OBJECT AND SUMMARY OF THE INVENTION

It is an object of the invention to counteract at least one of the disadvantages of the lighting device according to the prior art. To this end, the lighting device of the type as described in the opening paragraph is characterized in that the adjustment comprises a change in shape of the reflector and/or a change in the mutual position of the reflector and the contacting element. The adjustment is temporary but will not change spontaneously, i.e. once the reflector is set in a first position/shape, it will remain in said position/shape until it is set to a second or further shape/position by external handling. As the lighting device is especially designed for regular adjustment of the reflector, firm positioning of the reflector is not required and hence the lighting device has the advantage that simplified adjustment of the reflector is enabled, for example, in that the reflector is provided at its fixation means with gripping means for easy gripping and adjustment of the reflector by a user, or in that the reflector is permanently fixed at one of its ends to the rim of the housing and said gripping means and/or fixation means are provided at the opposite end of the reflector. If the reflector is permanently fixed at one of its ends to the rim of the housing, adjusting the shape of the reflector becomes easier, as this can be done with only one hand. By providing the fixation means, optionally jointly with the gripping means, at one of the reflector ends, the two technical features of the reflector, i.e. the reflective part for reflecting light and the fixation/gripping part for adjustment of the reflector, are physically separated, thus simplifying the construction/manufacture of the reflector. Furthermore, the lighting device has the advantage that the shape of the light beam to be issued from the lighting device during its operation can be (approximately) adjusted to a desired shape by adjusting the shape of the reflector. The light source could be, for example, a halogen incandescent lamp, an LED or a plurality of LEDs, a low-pressure mercury discharge lamp, a high-intensity discharge lamp, for example a metal halide lamp, HPS or CDM. The lighting device as such could be embodied as a luminaire or, for example, the lighting device mounted on a street lamp pole is a luminaire, or the lighting device is suspended from a ceiling, or is a recessed luminaire built into a false ceiling.

An embodiment of the lighting device is characterized in that the reflector is divided into at least two, separately adjustable sub-reflectors. By virtue thereof, the lighting device has the advantage that a plurality of different beam shapes could be issued by one lighting device, i.e. each sub-reflector creates its own desired beam shape.

An embodiment of the lighting device is characterized in that the light emission window is divided into at least two, separately adjustable light emission sub-windows. By virtue thereof, the lighting device has the advantage that beams can be issued in a plurality of different directions by one lighting device, i.e. each light emission window creates its own desired beam direction when the light emission windows are in mutually rotated positions.

An embodiment of the lighting device is characterized in that the housing of the lighting device comprises a central body extending along a lighting device axis and dividing the reflector and/or the light emission window into respectively the sub-reflectors and/or the light emission sub-windows. The fixation and/or gripping means for both sub-reflectors could be located at or inside the central body, causing the luminaire to be relatively compact. Furthermore, if a starter and/or driver are required for the at least one light source, these could be housed inside said central body. Also, the at least one contacting element could be housed in the central housing, thus enabling the light sources accommodated in the contacting element to provide light to both reflectors simultaneously, or the light sources could be centrally housed in contacting elements dedicated to a respective reflector.

An embodiment of the lighting device is characterized in that the lighting device is mirror symmetrical with respect to a plane extending along the central body and through the lighting device axis and perpendicular to the light emission window. As a result, the cost price of the lighting device is reduced and assembly of the lighting device is simplified as the number of different parts is reduced.

An embodiment of the lighting device is characterized in that the sub-reflectors are mutually rotatable around the lighting device axis. Thus, simple redirection of the light beams as issued by the luminaire during its operation is enabled. Light beams can be directed in the same direction, and possibly overlap, to locally enhance the illumination level, i.e. more or less form a spot-light, or the light beams can be directed in different directions to illuminate a relatively wide area, i.e. thus forming a sort of flood light.

An embodiment of the lighting device is characterized in that the reflector is made of resilient material. In a relaxed position of the reflector in which no external force is exerted on the reflector (not considering gravity), the reflector then assumes its basic shape, which is the standard starting point for adjustment of the reflector to obtain the desired illumination to be provided by the lighting device. Furthermore, the resilience of the material enhances the fixation of the reflector when the holding means and gripping means have an interlocking mating structure, thus forming mutually engaged parts, as due to its resilience a permanent press force is exerted on the engaged parts, thus counteracting unintended mutual disengagement of said engaged parts.

An embodiment of the lighting device is characterized in that holding means and gripping means have an interlocking matching structure. Convenient interlocking structures which enable easy adjustment of the reflector are, for example, a saw-tooth structure, a pin and hole combination, an eye and hook combination. The adjustment of the reflector then occurs via a step function. Alternatively, an embodiment of the lighting device is characterized in that the holding means and fixation means are mutually attracting magnetic and/or magnetizable parts. Only one part must be permanently magnetic, or electro-magnetic, the other part could be permanently magnetic or electro-magnetic or could be made of a magnetizable material, for example ferro-magnetic materials such as iron, neodymium, or nickel. Then, step-wise adjustment of the reflector is not imposed, but rather adjustment of the reflector via a continuously shiftable system is enabled, thus providing a relatively precise/accurate adjustment of the lighting device. Such a continuously shiftable system could be controlled in an active way, for example by a servo motor system, or in a passive way, for example by hand.

An embodiment of the lighting device is characterized in that the light emission window is provided with a light-permeable cover. The cover counteracts pollution of the reflector and additionally could be used to diffuse light or reduce glare, for example in that the cover is opaquely translucent.

### BRIEF DESCRIPTION OF THE DRAWINGS

The present invention will now be further elucidated in greater detail with reference to the schematic drawings which are intended to illustrate, not limit, the invention, and in which similar parts are indicated by the same reference signs, and in which:

FIGS. 1A-1B show a cross sectional view of a first embodiment of the lighting device of the invention with a reflector in respectively a first and a second position/shape;

FIG. 2 shows a perspective view of the lighting device of FIG. 1A;

FIG. 3 shows a partial, cross sectional view of a second embodiment of the lighting device according to the invention;

FIG. 4 shows a perspective view of the lighting device of FIG. 3;

FIGS. 5A-5B show a cross sectional view of a third embodiment of the lighting device of the invention with a reflector in respectively a first and a second position/shape.

### DESCRIPTION OF EMBODIMENTS

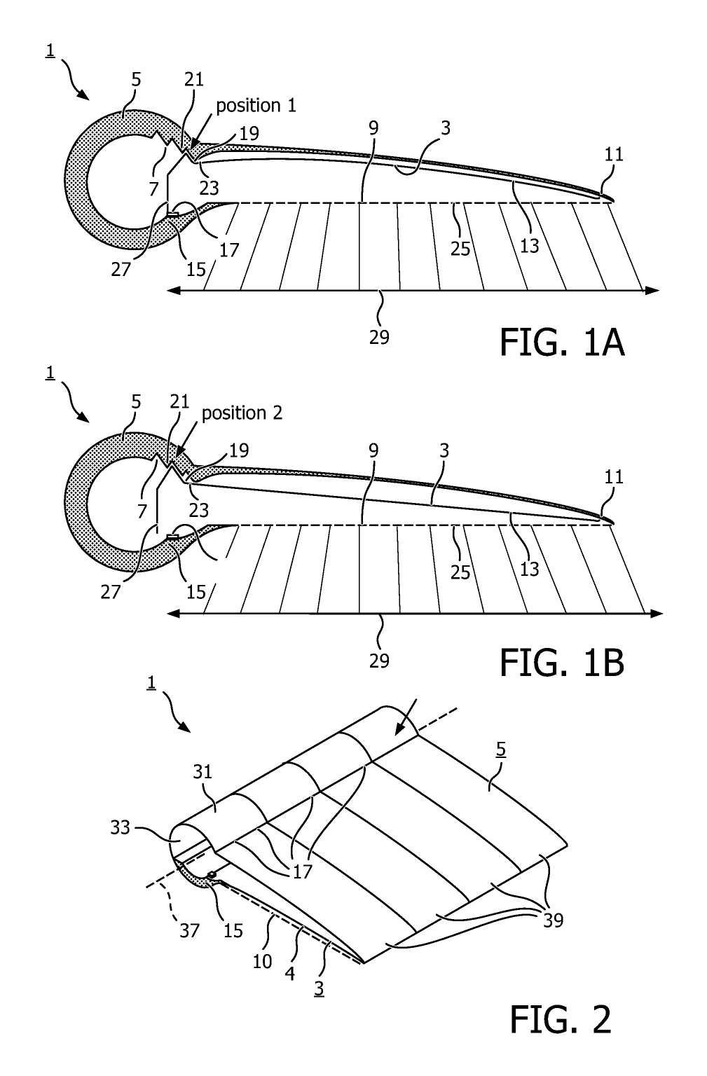

In FIGS. 1A-1B, a cross sectional view of a first embodiment of the lighting device 1 of the invention is shown with an adjustable reflector 3 in respectively a first and a second shape. The lighting device is a luminaire comprising a housing 5 with holding means 7, in FIGS. 1A-1B a saw-tooth structure, for fixation of the reflector inside the housing. A light emission window 9 is located opposite the reflector. A rim 11 of the housing, in which the reflector is fixed with a first end 13, forms part of a border of the light emission window. At least one electric contacting element 15 is provided and accommodates at least one light source 17 inside the housing. The reflector 3 is provided with fixation means 19 having a fitting, mechanical, interlocking structure 21 with respect to the holding means; the fixation means in the Figures is a protruding ridge at a second end 23 of the reflector. The luminaire is provided, in the light emission window, with a light-permeable, opaque cover 25. The fixation means and the holding means cooperate via their mutually fitting structure and enable adjustment of the reflector within the housing. As shown in FIGS. 1A-1B, the adjustment comprises a change from, respectively, a slightly curved shape of the resilient reflector, being forced to abut against the housing, to a straight shape of the reflector in a relaxed position. The change of the shape of the reflector results in a changed beam pattern 29 of the light issued from the luminaire. To enable easy adjustment of the reflector by a user, the reflector is provided with gripping means 27 at its second end.

FIG. 2 is a perspective view of the lighting device 1 of FIG. 1A. In FIG. 1B it is visible that the reflector 3 consists of four sub-reflectors 4, but in other embodiments this number could be different, for example two, three, six, fifteen, or each sub-reflector could be associated with a single LED or LED-combination. Each sub-reflector is associated with a respective wing part 39 of the housing 5, which four wing parts all assume the same mutual orientation but which are individually pivotable around axis 37 extending through a hollow, tube-shaped body 31 at the second end 23 of the reflector 3/sub-reflectors 4. Thus, the light emission window is divided into four separately adjustable light emission sub-windows (10). The tube-shaped body is part of the housing 5 and encloses a space 33 in which a plurality of contact elements 15 and light sources 17, in the figure LEDs, are located. The LEDs could be white light emitting LEDs, or any selection or combination of red, blue, green, amber LEDs, enabling a desired color setting of the light issued by the luminaire during its operation. The lighting device is mountable with its tube-shaped body onto a wall, a pole, or a ceiling.

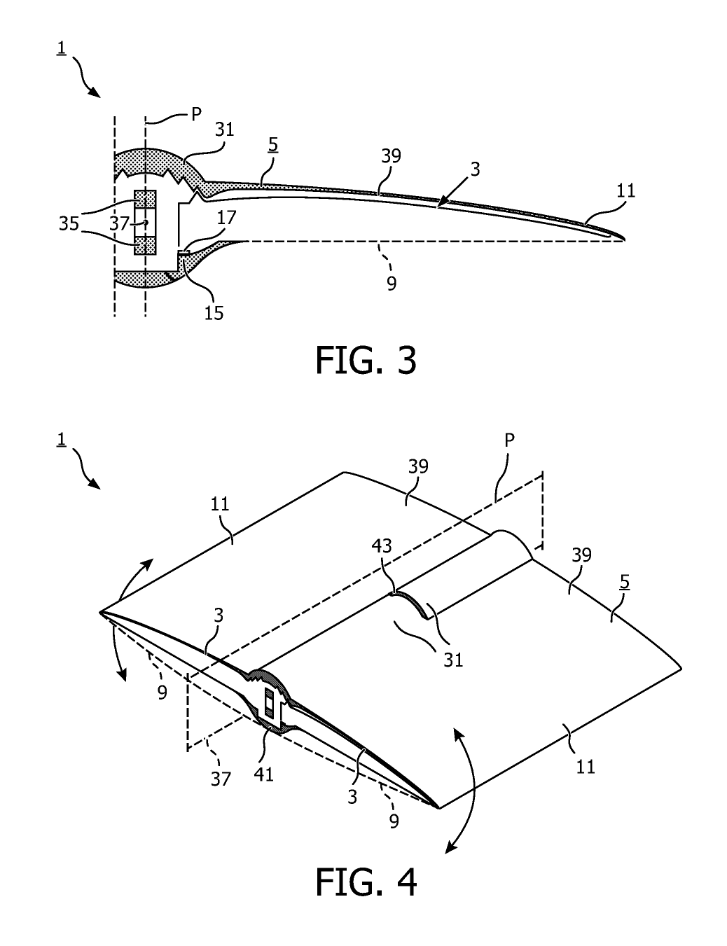

FIG. 3 is a cross sectional view of approximately only one half of a second embodiment of the lighting device 1 according to the invention. The lighting device is a luminaire with two light emission windows 9, separated by a central, hollow, tube-shaped body 31, being part of housing 5, in which contact elements 15, light sources 17 and electronic drivers 35 are housed along a lighting device axis 37. The luminaire 1 has substantially mirror symmetrical wing parts 39 with respect to a plane P extending along the central body 31 and through the axis and perpendicular to an average orientation of the two light emission windows 9 bordered by the rims 11 of the housing, see also FIG. 4.

FIG. 4 is a perspective view of the lighting device 1 of FIG. 3, however, with a slightly mutually rotated orientation of the reflectors 3 through axis 37, i.e. the wing parts 39 of housing 5 together with the respective resiliently abutting reflectors are mutually rotated through axis 37. Said wing parts 39 are interconnected via a hinge connection 43 in the central tube-shaped part 31. The luminaire of FIG. 4 can be mounted with a tube end 41 to external mounting means, for example a wall or a street pole (not shown). By setting the mutual orientation of the two reflectors, a desired beam direction and hence lighting distribution is obtainable, for example for simultaneous shop window illumination and illumination of the pavement in front of said shop window.

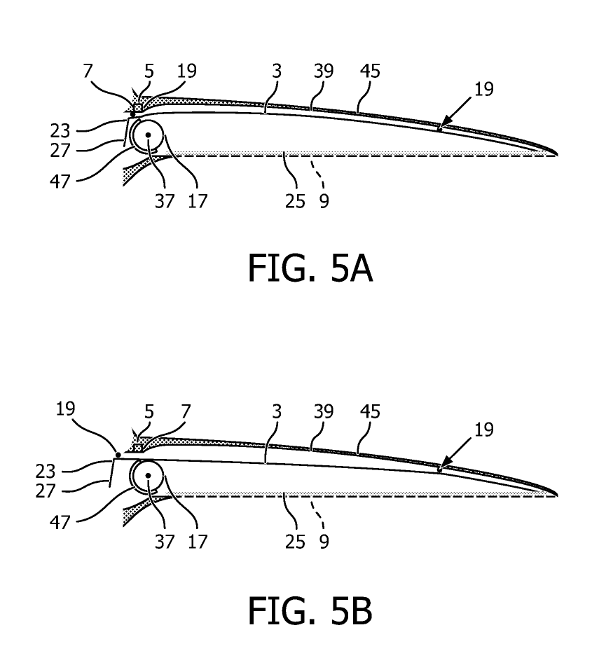

FIGS. 5A-5B are cross sectional views of a third embodiment of the lighting device 1 of the invention, with only one reflector 3 in respectively a first and second position/shape. In FIGS. 5A and 5B, the holding means 7 and fixation means 19 are parts that mutually attract one another magnetically. The wing parts 39 of housing 5 are made of ferro-magnetic metal and form part of the holding means. The fixation means 19 are permanent magnets and provided both at a relatively central portion 45 of the reflector and at the second end 23 of the reflector. Both fixation means are continuously shiftable along the wing parts 39 in a direction transverse to the axis 37, enabling both a change in shape of the reflector and continuous displacement of the reflector with respect to the contacting element in which light source 17 is accommodated, as shown in FIGS. 5A-5B. In the examples shown in FIGS. 5A-5B, the fixation means at the second end of the reflector is shifted while the position of the fixation means at the central portion of the reflector remains unchanged, however, the fixation means at the central portion of the reflector is shiftable as well. In this embodiment, the adjustment of the continuously shiftable reflector is done passively, i.e. by hand. For this purpose, the reflector is provided at its second end 23 with gripping means 27. The light source 17 is an elongated low-pressure mercury discharge lamp extending along the axis 37, for example a fluorescent tube provided with a mirror coating 47 on a side of the tube facing away from the light emission window 9. The light emission window is provided with a transparent cover 25 made of, for example, PMMA.

1. A lighting device comprising:
a housing with holding means for fixation of an adjustable reflector inside the housing, a rim of the housing bordering a light emission window opposite the reflector;
at least one electric contacting element for accommodating at least one light source inside the housing;
the reflector being provided with fixation means having a structure which fits that of the holding means and which enables adjustment of the reflector within the housing, said adjustment comprises a change in shape of the reflector and/or a change in the mutual position of the reflector and the contacting element,
wherein the housing comprises a central body extending along a lighting device axis and connecting two wing parts of the housing, said central body dividing the reflector and/or the light emission window into respectively sub-reflectors and/or light emission sub-windows, the wing parts together with the sub-reflectors are mutually rotatable around the lighting device axis.

2. (canceled)

3. A lighting device as claimed in claim 1, wherein the light emission window is divided into at least two, separately adjustable light emission sub-windows.

4. (canceled)

5. A lighting device as claimed in claim 1 wherein the central body comprises the at least one contacting element and houses a driver for the at least one light source.

6. A lighting device as claimed in claim 1 wherein the lighting device is mirror symmetrical with respect to a plane (P) extending along the central body and through the lighting device axis and perpendicular to the light emission window.

7. (canceled)

8. A lighting device as claimed in claim 1, wherein the reflector is made of resilient material.

9. A lighting device as claimed in claim 1, wherein holding means and gripping means have an interlocking matching structure.

10. A lighting device as claimed in claim 9, wherein the interlocking structure is chosen from the group consisting of a saw-tooth structure, a pin and hole combination, an eye and hook combination.

11. A lighting device as claimed in claim 1, wherein the holding means and fixation means comprise mutually attracting magnetic and/or magnetizable parts.

12. A lighting device as claimed in claim 1, wherein the reflector is permanently fixed, at one of its ends, to the rim of the housing.

13. A lighting device as claimed in claim 1, wherein the reflector is provided, at its fixation means, with gripping means.

14. A lighting device as claimed in claim 1, wherein the light emission window is provided with a light-permeable cover.
